(19) United States
(12) Patent Application Publication
(10) Pub. No.: US 2005/0003154 A1
(43) Pub. Date: Jan. 6, 2005

(54) Laminated building panels having preselected colors

(76) Inventors: Gary L. White, Sherman, TX (US); Thomas L. Levendusky, Greensburg, PA (US); Steven J. Baker, Sidney, OH (US); James W. Melvin, Denison, TX (US)

Correspondence Address: ECKERT SEAMANS CHERIN & MELLOTT, 600 GRANT STREET, 44TH FLOOR, PITTSBURGH, PA, 15219, US

(21) Appl. No.: 10/817,604

(22) Filed: Apr. 2, 2004

Related U.S. Application Data
(63) Continuation-in-part of application No. 10/318,427, filed on Dec. 13, 2002.

(51) Int. Cl. B32B 1/00

(52) U.S. Cl. 428/141; 156/249; 264/216

(57) ABSTRACT

Plastic building panels for exterior use on buildings are made by forming a plastic sheet at an elevated temperature, overlaying an exterior surface portion of the formed sheet with a coloring sheet having a preselected color, and thermally bonding the coloring sheet to the formed sheet. The coloring sheet may comprise a vinyl resin plastisol and pigment particles. Both the formed sheet and the vinyl resin in the plastisol may comprise polyvinyl chloride (PVC). The coloring sheet can be configured with a matte surface substantially without the use of flattening agents, and an adhesion system can be used to augment the lamination between the coloring sheet and the plastic sheet. The coloring sheet can also be configured to have a predetermined pattern, such as may be provided with a plurality of coloring materials having multiple colors.

### CROSS-REFERENCE TO RELATED APPLICATION

The instant application is a continuation-in-part application of U.S. patent application Ser. No. 10/318,427, filed Dec. 13, 2002, the disclosures of which are incorporated herein by reference.

### BACKGROUND OF THE INVENTION

1. Field of the Invention

The invention relates to laminated plastic siding panels suitable for use on buildings. More specifically, the invention relates to a laminated plastic building panel including a coloring sheet and to a related method.

2. Background of the Invention

Processes for making plastic siding panels having preselected colors are known in the prior art. A commonly used manufacturing process involves coextruding at least two molten layers each including polyvinyl chloride (PVC) and various additives. Both the topcoat and the basecoat layers contain organic or inorganic pigments, fillers, heat stabilizers, impact modifiers, processing aids, and lubricants. Other suitable additives include antioxidants, flame retardants, and light stabilizers. Generally the basecoat layer is thicker than the topcoat layer and the basecoat layer contains a smaller proportion of pigments and other additives, in order to reduce material costs.

Thermoplastic polymers other than PVC may be used for making extruded plastic siding panels. Some other useful thermoplastic polymers include polyolefins (e.g. polypropylene and polyethylene), polycarbonates, acrylics, polyvinyl fluorides, polystyrenes cellulosics, and nylons.

Plastic siding panels can be made in a variety of attractive colors and they may be embossed with simulated wood grain patterns. The colors preferably resist fading even after exposure to outdoor light for several years. Siding panels preferably are also strong enough to resist high winds, have a relatively high flexural modulus, and are resistant to distortion accompanying temperature changes. Because plastic siding panels possess these desirable attributes and are still relatively inexpensive compared with wood and metal, they have achieved widespread use in North America on exterior surfaces of residential and commercial buildings.

Plastic siding panels are generally manufactured in long runs of a single color, usually carried out for 24 hours or more. Siding manufacturers are reluctant to operate their extruders for shorter times because changeovers from one color to a different color require a downtime of at least several minutes because of the need to change the color of at least one layer fed to the extruder. As a result, siding manufacturers are forced to maintain larger inventories of many siding colors than would otherwise be needed to satisfy customer demand. Accordingly, there remains an opportunity for a process of producing plastic siding panels in a variety of preselected colors, wherein color changes can be accomplished quickly, efficiently, and economically.

### SUMMARY OF THE INVENTION

In accordance with the invention there is provided a laminated plastic siding panel suitable for use on buildings, as well as an associated method, and a coloring sheet for use in laminated plastic siding panels suitable for use on buildings, as well as an associated method. Laminated siding panels of the invention are similar to vinyl siding panels now covering building exteriors in a variety of attractive colors including Pebblestone Clay, Sawmill and Musket Brown, as well as other colors.

The laminated plastic siding panel of the invention comprises a plastic sheet to which a coloring sheet is bonded, to impart a desired color. The plastic sheet may comprise a single layer or, less preferably, two or more layers bonded to each other. The plastic sheet is preferably extruded from molten polymer compounds containing thermoplastic polymers and other additives. Some useful thermoplastic polymers include polyvinyl chloride (PVC), polyolefins (e.g. polypropylene and polyethylene), polycarbonates, acrylics, polystyrenes, cellulosics, nylons, and other suitable thermoplastics. If desired, some of the PVC may be reprocessed scrap material.

The plastic sheet contains various additives in addition to PVC. Such additives include various pigments, fillers, heat stabilizers, impact modifiers, processing aids, and lubricants. Other suitable additives include antioxidants, flame retardants, and light stabilizers. Some suitable pigments and fillers include titanium dioxide, calcium carbonate, kaolin clay, silica, talc, zinc oxide, magnesium hydroxide, alumina trihydrate, Pigment Red 101 (iron oxide red), Pigment Yellow 119 (zinc iron pigment), Pigment Green 48, and organic pigments of various colors.

The heat stabilizer additives are preferably organotin compounds including the alkyl mercaptides, maleates, and carboxylates. Some examples of suitable organotin stabilizers are dialkyltin allyl mercaptides, dibutyltin maleate, modified butyltin maleates, octyltin mercaptocarboxylic acids, dibutyltin dilaurate, and organotin derivatives of 2-mercaptoethanol. The organotin stabilizer preferably is present at a concentration of about 0.2-2 parts per 100 parts unplasticized polyvinyl chloride resin (0.2-2 phr). Other heat stabilizers for PVC include 3-diketones and mixed metal carboxylates. The impact modifiers may comprise chlorinated polyethylene, acrylic polymers, acrylonitrile-butadiene-styrene resins, ethylene-vinyl acetate copolymers, and ethylene-vinyl acetate/vinyl chloride graft copolymers. One suitable group of impact modifiers is sold by Rohm & Haas Company under the trademark ACRYLOID. The impact modifiers are typically employed at a level of about 0.4-10 phr.

A suitable processing aid is a low viscosity acrylic copolymer. Some useful lubricants include calcium, aluminum, magnesium and zinc stearates, and various soaps, waxes, and fatty acid derivatives. Optionally, the plastic sheet may contain any of several antimicrobial compounds to prevent mildew, including various isothiazolones and diphenyl ethers.

In accordance with the invention a molten polymer compound is extruded through an opening in an extrusion die to form a molten plastic sheet. Less preferably, the molten plastic sheet may be formed by coextruding two or more webs through adjacent extrusion dies and then pressing the webs together while they are still in a viscoelastic state.

In order to impart a desired color to the plastic building panel of the invention, the molten plastic sheet is laminated with a coloring sheet. The coloring sheet of the invention may formed into a sheet by any of several techniques including extrusion, blowing, spread coating, electrostatic casting or solution casting of at least a first flowable material comprising a binder, at least one plasticizer for the binder, at least one organic solvent, and particles of a pigment imparting a preselected color, and by heating the flowable material to drive off at least some of the solvent, thereby forming a coloring sheet, and winding the coloring sheet into a roll for later lamination with the plastic sheet.

The binder is preferably vinyl resin plastisol comprising a vinyl resin, at least one plasticizer for the vinyl resin and at least one organic solvent. The vinyl resin comprises at least one resin selected from vinyl chloride homopolymers, copolymers of vinyl chloride with vinylidene chloride or with vinyl esters of carboxylic acids containing 2 to 10 carbon atoms; and acrylate homopolymers and copolymers. Plastisols of polyvinyl chloride (PVC) are particularly preferred. Plastisols may also include acrylics and/or polyvinylidene fluoride, alone or in combination with a vinyl resin.

The plasticizer for the vinyl resin may be a carboxylic acid diester, tricresyl phosphate and other esters of orthophosphoric acid, acetyltributyl citrate, or a saturated or unsaturated polyester of liquid epoxide compounds. Some preferred plasticizers are diesters of dicarboxylic acids with saturated alcohols, including diisodecyl phthalate (DIDP); nonanedioic acid, bis (2-ethylhexyl) ester; and trimethyl-1,3-pentanediol diisobutyrate (TXIB). The organic solvent may be naphtha, toluene, xylene, mineral spirits, and mixtures including such solvents.

Some suitable pigments imparting color to the coloring sheet include titanium dioxide, aluminum trihydroxide, iron oxide, silica, calcium carbonate, zinc oxide, magnesium hydroxide, carbon black, various organic pigments, and mixtures thereof. Coloring sheets made in accordance with the invention may generally contain some titanium dioxide. Other pigments in the coloring sheet will vary, depending upon the particular color or colors to be imparted to the sheet. The vinyl plastisol preferably also includes a thixotropic agent such as amorphous silica, an anti-chalking agent such as antimony trioxide, and optionally an ultraviolet stabilizer. Optionally, an antimicrobial compound may be added to the plastisol. Suitable antimicrobial compounds include isothiazolones and diphenyl ethers.

The coloring sheet is laminated to the extruded plastic sheet by overlaying the plastic sheet with a coloring sheet and then passing the coloring sheet through a pair of opposed, rotating rolls. Shaper dies then shape the panel into a desired three-dimensional configuration while it is still in a viscoelastic condition. The shaped panel is solidified by cooling, preferably with water, and then punched with openings and cut into desired lengths for packaging, followed by shipment to customers.

The coloring sheet may be provided with a matte finish substantially without any need to add flattening agents to the coloring material by curing the coloring material on a substrate having a textured surface. An absence of flattening agents improves the working properties of a coloring sheet during the lamination process. After curing, the removal of the coloring sheet from the substrate exposes a surface of the coloring sheet that had been adjacent the substrate, and the exposed surface has a matte finish that results from the textured surface of the substrate. The coloring sheet may also have a glossy finish on a surface opposite the surface having the matte finish and that is relatively more glossy than the matte finish as measured in an ascertainable fashion, such as with the use of a glossmeter, such as might include a 75 degree glossmeter or other glossmeter, or another instrument.

The laminated plastic building panel may include an adhesion system that helps to maintain a lamination bond between the plastic sheet and the coloring sheet. The adhesion system may include one or both of an adhesion promoter within the coloring sheet and a primer disposed generally between the plastic sheet and the coloring sheet.

The coloring sheet may be formed with a plurality of coloring materials that may be of different colors and that may enable the resultant laminated plastic building panel to have an enhanced appearance. A first coloring material may be formed on a substrate according to a predetermined pattern, and a second coloring material may then be formed on the substrate in contact with the first coloring material. Upon removal of the coloring sheet from the substrate, the coloring sheet may be laminated to a plastic sheet with the first coloring material facing away from the plastic sheet to form a laminated plastic building panel. The pattern of the first coloring material may be of a wood grain or other pattern, and the pattern may be ordered or may be a random pattern, such that the first coloring material provides to the laminated plastic building panel an enhanced appearance by providing a plurality of colors and/or a texture.

Accordingly, and aspect of the invention is to provide an improved method of forming a coloring sheet having a preselected color and being structured to be laminated to a plastic sheet to form a laminated plastic building panel suitable for use on a building, in which the general nature of the method can be generally stated as including applying onto a support surface of a substrate a flowable initial material having a polymeric binder and a pigment material, the binder including a plastisol, the support surface having a texture, curing the flowable initial material to form a relatively less flowable coloring material disposed on the support surface, the coloring material having a first surface and a second surface, the first surface being disposed adjacent the support surface and the second surface being disposed opposite the first surface, and employing the texture of the support surface to provide the first surface with a matte finish when the coloring material is removed from the substrate.

Another aspect of the invention is to provide an improved method of forming a laminated plastic building panel having a preselected color and being suitable for use on a building, in which the general nature of the method can be generally stated as including applying onto a support surface of a substrate a flowable initial material having a polymeric binder and a pigment material, the binder including a plastisol, the support surface having a texture, curing the flowable initial material to form a sheet of relatively less flowable coloring material disposed on the support and having a first surface adjacent the support surface, providing the first surface with a matte finish by curing the flowable initial material adjacent the support surface, removing the sheet of coloring material from the substrate, providing a plastic sheet, and laminating together the plastic sheet and the sheet of coloring material, with the first surface of the sheet of coloring material facing away from the plastic sheet.

Another aspect of the invention is to provide an improved coloring sheet structured to be laminated to a plastic sheet to form a laminated plastic building panel having a preselected color and being suitable for use on a building, in which the general nature of the coloring sheet can be generally stated as including a sheet of coloring material having a preselected color and having a polymeric binder and a pigment material, the binder including a plastisol, the sheet of coloring material having a first surface and a second surface, the first surface having a matte finish, and the second surface having a glossy finish that is relatively more glossy than the matte finish of the first surface.

Another aspect of the invention is to provide an improved laminated plastic building panel having a preselected color and being suitable for use on a building, in which the general nature of the plastic building panel can be generally stated as including a plastic sheet, a coloring sheet having a polymeric binder and a pigment material, the binder including a plastisol, the plastic sheet and the coloring sheet being laminated together, an adhesion system that enhances the laminated adhesion of the plastic sheet with the coloring sheet, and the adhesion system including at least one of an adhesion promoter in the coloring sheet and a primer having an adhesion promoter and being disposed generally between the plastic sheet and the coloring sheet.

Another aspect of the invention is to provide an improved method of forming a coloring sheet having at least a first preselected color and being structured to be laminated to a plastic sheet to form a laminated plastic building panel suitable for use on a building, in which the general nature of the method can be generally stated as including applying onto a support surface of a substrate a first flowable material having a polymeric first binder and a first pigment material, the first binder including a plastisol, at least partially curing the first flowable material to form a relatively less flowable first coloring material disposed on the support surface, applying onto the substrate in contact with the first coloring material a second flowable material having a polymeric second binder and a second pigment material, the second binder including a plastisol, and performing a curing operation to form the first coloring material and the second flowable material into a coloring sheet having the first coloring material embedded therein.

Another aspect of the invention is to provide an improved method of forming a laminated plastic building panel having at least a first preselected color and being suitable for use on a building, in which the general nature of the method can be generally stated as including applying onto a support surface of a substrate a first flowable material having a polymeric first binder and a first pigment material, the first binder including a plastisol, at least partially curing the first flowable material to form a relatively less flowable first coloring material disposed on the support surface, applying onto the first coloring material a second flowable material having a polymeric second binder and a second pigment material, the second binder including a plastisol, performing a curing operation to form the first coloring material and the second flowable material into a coloring sheet having a first surface disposed on the support surface, at least a portion of the first coloring material being disposed at the first surface, removing the sheet of coloring material from the substrate to expose the first surface, providing a plastic sheet, and laminating together the plastic sheet and the sheet of coloring material, with the surface of the sheet of coloring material facing away from the plastic sheet.

Another aspect of the invention is to provide an improved coloring sheet structured to be laminated to a plastic sheet to form a laminated plastic building panel having at least a first preselected color and being suitable for use on a building, in which the general nature of the coloring sheet can be generally stated as including a sheet of coloring material including a first coloring material embedded in a second coloring material, the first coloring material having a first preselected color and having a polymeric first binder and a first pigment material, the first binder including a plastisol, the second coloring material having a second preselected color and having a polymeric second binder and a second pigment material, the second binder including a plastisol, and the first coloring material being distributed according to a predetermined pattern.

Another aspect of the invention is to provide an improved laminated plastic building panel suitable for use on a building, in which the general nature of the plastic building panel can be generally stated as including a plastic sheet, a sheet of coloring material including a first coloring material embedded in a second coloring material, the first coloring material having a first preselected color and having a polymeric first binder and a first pigment material, the first binder including a plastisol, the second coloring material having a second preselected color and having a polymeric second binder and a second pigment material, the second binder including a plastisol, and the plastic sheet and the coloring sheet being laminated together.

### BRIEF DESCRIPTION OF THE DRAWINGS

FIG. 1 is a flow sheet diagram of a particularly preferred process for making laminated plastic siding panels in accordance with the invention.

FIG. 2 is a flow sheet diagram of a preferred process for making the coloring sheet of the invention.

FIG. 3 is a top plan view of a portion of a coloring sheet in accordance with another embodiment of the invention formed on a substrate.

FIG. 4 is a sectional view of a portion of another coloring sheet in accordance with another embodiment of the invention.

FIG. 5 is a top plan view of a portion of another coloring sheet in accordance with another embodiment of the invention.

FIG. 6 is a sectional view of a portion of the coloring sheet of FIG. 5 during a first part of a process for manufacturing the coloring sheet.

FIG. 7 is a view similar to FIG. 6, except depicting another portion of the coloring sheet of FIG. 5 during a second part of the process for manufacturing the coloring sheet.

FIG. 8 is a flowchart illustrating a method of manufacturing the coloring sheet of FIG. 5.

FIG. 9 is schematic depiction of the method of FIG. 8.

FIG. 10 is a top plan view of a laminated plastic building panel incorporating the coloring sheet of FIG. 5.

Similar numeral refer to similar parts throughout the specification.

### DETAILED DESCRIPTION OF PREFERRED EMBODIMENTS

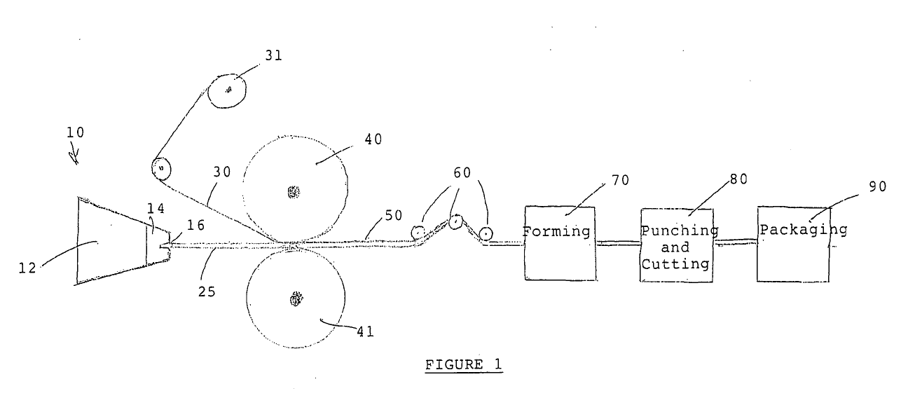

As shown in FIG. 1, an apparatus 10 for making laminated plastic siding panels in accordance with the invention includes an extruder 12 connected with a steel extrusion die 14 having a linear opening 16. The extruder 12 and die 14 are commercially available from American Maplan Corporation, of Mc Pherson, Kans., in a variety of designs and sizes that are adaptable to the quantity and speed of extrudate desired for particular applications.

The extrusion die 14 extrudes a molten plastic sheet 25 at an elevated temperature of at least about 300° F. (149° C.).

In order to impart a preselected color to the product, a coloring sheet 30 is laminated with the plastic sheet 25. The coloring sheet 30 is unwound from a supply roll 31 and fed continuously to a metal embossing roll 40 and a rubber backup roll 41, together with the plastic sheet 25. The plastic sheet 25 leaves the extruder die 14 at a temperature of about 385-400° F. When the plastic sheet 25 meets the coloring sheet 30 between the rolls 40, 41 the temperature of the sheet 25 is still high enough to bond the coloring sheet 30 to an outer surface portion of the plastic sheet 25. The embossing roll 40, if employed, may simultaneously impart a three-dimensional simulated wood grain texture or other texture to the coloring sheet 30. The product, a laminated plastic building panel 50 having an exemplary appearance similar to painted wood, is feed downstream to cooling rolls 60, a forming station 70 where the panel 50 is shaped into a desired configuration, then to a punching and cutting station 80 where holes are punched and the panel 50 is cut into desired lengths. Finally, at a packaging station 90 the product is boxed for shipment directly to customers or for temporary storage in the manufacturer's inventory.

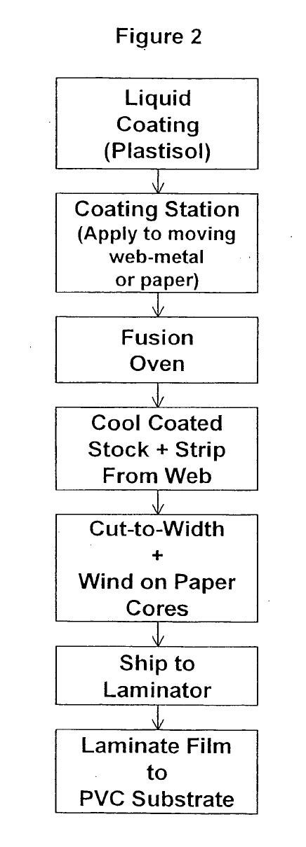

As shown in FIG. 2, coloring sheet of the invention is preferably made by a process that includes spread coating a thin film of a coloring material such as a vinyl plastisol onto a paper sheet, heating the thin film in a fusion oven to drive off some of the solvent in the plastisol, cooling the film, stripping the film from the paper sheet, cutting the coloring sheet to a desired width, and then winding the dried coloring sheet onto paper cores. Alternatively, the coloring sheet may be made by casting a thin film of the plastisol onto a moving web (paper, metal or polymer).

The vinyl plastisol of the invention comprises a dispersion of finely divided plasticized polyvinyl chloride. The plastisol may comprise about 25-50 wt % PVC, preferably about 42-48 wt %, and about 45 wt % in a particularly preferred embodiment. The plasticizer comprises about 16-24 wt % of the plastisol, preferably about 20-23 wt %, and about 21 wt % in a particularly preferred embodiment. A particularly preferred plastisol contains 3 plasticizers—about 9.9 wt % diisodecyl phthalate; about 5.9 wt % nonanedioic acid, bis (ethylhexyl) ester; and about 5.4 wt % trimethyl-1,3-pentaediol diisobutyrate.

The vinyl plastisol may contain about 18-35 wt % pigment particles, preferably about 20-25 wt % in a particularly preferred embodiment. A particularly preferred composition includes about 21.0 wt % titanium dioxide to impart a whitish color and to protect the PVC from light, about 1.2 wt % aluminum hydroxide, and about 1.2 wt % amorphous silica. The silica also acts as a thioxotropic agent.

The plastisol includes about 5-15 wt % organic solvents. Some suitable solvents include toluene, naphtha, xylene, mineral spirits, and solvent mixtures including such solvents.

Other suitable additives in the vinyl plastisol include anti-chalking agents, UV light stabilizers, and fumed silica for reducing gloss. A particularly preferred plastisol contains about 0.6 wt % antimony trioxide, an anti-chalking agent.

It has been learned that a glossy outer finish in a laminated plastic building panel can provide an undesirable appearance to the panel when employed as siding for a building. A spread coating operation for forming film such as described above can result in a film having a surface with an undesirably glossy finish. While various known flattening agents can be employed in the coloring material to provide more of a matte finish to the resultant film, it is also known that such flattening agents tend to interfere with the workability of the film, such as by increasing brittleness and/or stiffness of the film and/or imparting other undesirable working properties.

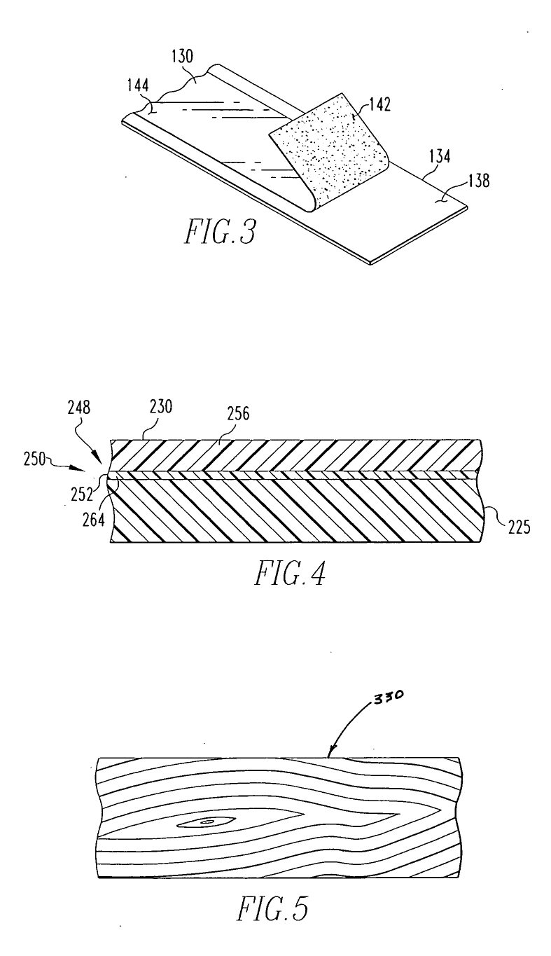

An improved coloring sheet 130 in accordance with another embodiment of the invention is depicted generally in FIG. 3 and alleviates the need to add such flattening agents to the coloring material. The improved coloring sheet 130 may be formed by applying a coloring material such as described above that is substantially devoid of flattening agents onto a substrate 134 having a support surface 138 that has a texture, and by curing the coloring material. Such curing may, for instance, occur by passing the coloring material through an oven at a temperate in the range of about 375°-425° F. for an appropriate duration of time to fuse together the plastic particles thereof.

By curing the coloring material against the textured support surface 138, the resultant coloring sheet 130 has a first surface 142 disposed adjacent the substrate 138 which, when exposed upon removing the coloring sheet 130 from the substrate 134, has a matte finish. As used herein, the expression “matte” and variations thereof shall refer broadly to the property of being relatively unglossy or as being relatively less glossy than a reference level of glossiness. Degrees of glossiness, such as in respect of matte and glossy finishes, can be measured in known fashions, such as with a glossmeter or other instrument. Such a glossmeter may be a 75 degree glossmeter or other glossmeter. The coloring sheet 130 also includes a second surface 144 that is opposite the first surface 142 and that has a glossy finish that is relatively glossier than the matte finish of the first surface 142.

The substrate 134 can be many materials having a texture and, for example, may be made at least partially of paper, such as might include a web of paper. An exemplary substrate 134 would include a web of paper such as PLG 2150 (S/K HER Matte 3922/104) supplied by Sappi Fine Paper North America, which is a division of Sappi Ltd. Of Johannesburg, South Africa, although numerous other materials could be employed.

An improved laminated plastic building panel 250 in accordance with another embodiment of the invention is depicted generally in FIG. 4 in section. The laminated plastic building panel 250 includes a plastic sheet 225, a coloring sheet 230, and an adhesion system 248. In the exemplary embodiment depicted in FIG. 4, the adhesion system includes a primer 252, which is depicted as a layer of material disposed between the plastic sheet 225 and the coloring sheet 230, and an adhesion promoter 256 disposed within the coloring sheet 230. The exemplary coloring sheet 230 includes PVC base resins, and an exemplary material which can be employed as the adhesion promoter 256 in such a circumstance is methacrylate. The primer 252 also includes an adhesion promoter 264 which, in the exemplary embodiment is methylmethacrylate.

The adhesion system 248 helps the laminated bonding of the plastic sheet 225 with the coloring sheet 230 and resists delamination thereof. It is noted, however, that in other embodiments (not depicted herein) the adhesion system 248 may contain only one of the primer 252 and the adhesion promoter 256 in the coloring sheet 230 without departing from the concept of the invention.

An improved coloring sheet 330 in accordance with another embodiment of the invention is depicted generally in FIG. 5. The coloring sheet 330 is formed from a plurality of coloring materials which can impart to the coloring sheet 330 a preselected design having a plurality of colors and/or a texture. The coloring sheet 330 can advantageously be manufactured with a single inline process, thereby advantageously avoiding the need to provide intermediate materials and to rework the intermediate materials to provide final materials.

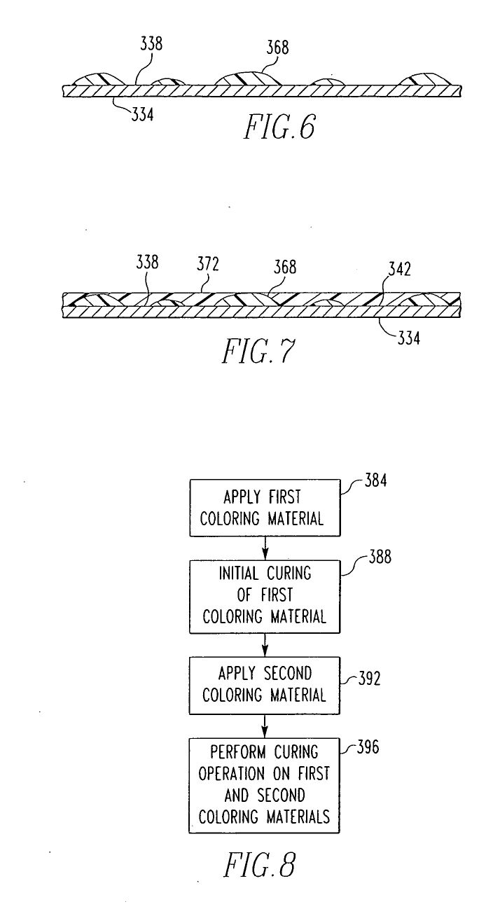

In order to manufacture the coloring sheet 330, a first coloring material 368 is applied to a support surface 338 of a substrate 334, as is depicted generally in FIG. 6 in section. The first coloring material 368 may be a coloring material as set forth above and may be applied according to a predetermined pattern. As used herein, the expression “pattern” and variations thereof shall refer broadly to any spatial arrangement, whether or not ordered, and can be random. For instance, the predetermined pattern may be that of a simulated wood grain. Similarly, the predetermined pattern could be an ordered pattern such as a grid or a symmetrical distribution of dots, for example. Similarly, the predetermined pattern could be a random pattern of lines, dots, and/or other shapes, for example. The application of the first coloring material 368 to the substrate 334 can be considered to be almost in the nature of a printing operation, meaning that the first coloring material is placed on the substrate 334 in a predetermined fashion and can be of any desired configuration.

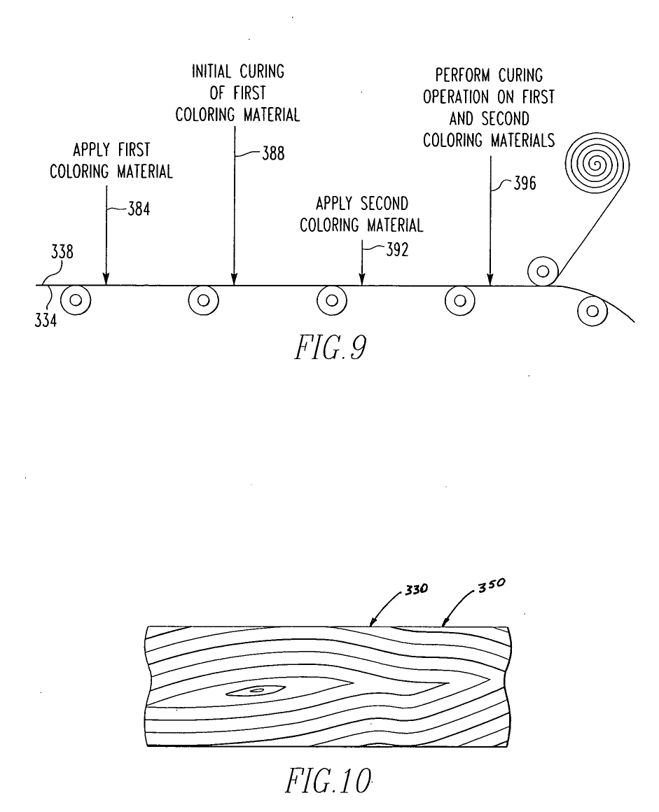

The first coloring material 368, when first applied to the substrate 334, is in a flowable condition, meaning that it exhibits at least some of the properties of a fluid, whether Newtonian or non-Newtonian. After the first coloring material 368 has been applied to the substrate 334, as at 384 in FIGS. 8 and 9, the first coloring material 368 is subjected to a first curing operation, as at 388, which at least partially cures the first coloring material 368 from its initial flowable condition to a relatively less flowable condition. Such an initial curing operation may occur by passing the first coloring material 368 through an oven having an elevated temperature sufficient to cause the first coloring material 368 to gel somewhat or to at least partially solidify or become relatively more viscous. It is understood that the initial curing operation may, if desired, fully cure the first coloring material 368, in which case the plastic particles thereof may have become fused together.

After the initial curing operation is performed on the first coloring material 368, a second coloring material 372 is applied, as at 392, to the substrate 334 in contact with the first coloring material 368, such as is depicted generally in FIG. 7. The second coloring material 372 may be of a different color, or may be of the same color, depending upon the desired final configuration of the coloring sheet 330. The second coloring material 372 is also in an initially flowable condition and, in the depicted example, flows about the first coloring material 368 such that the first coloring material 368 is embedded in the second coloring material 372. As used herein, the expression “embedded in” and variations thereof shall refer broadly to a condition in which first item is at least partially disposed within or is at least partially surrounded by a second item.

A curing operation is then performed, as at 396, on the first and second coloring materials 368 and 372 to transform the first and second coloring materials 368 and 372 into the coloring sheet 330. In this regard, the first and second coloring materials 368 and 372 likely are cured to a generally solid condition, with the curing of the first coloring material 368 during such operation being to the extent that the first coloring material 368 was not already cured to, for instance, a generally solid condition by the initial curing operation described above. After curing, the coloring sheet 330 includes a first surface 342 disposed adjacent the support surface 338 of the substrate 334. At least a portion of the first coloring material 368 is disposed at the first surface 342.

As mentioned above, the final coloring sheet 330 is depicted generally in FIG. 5 and includes an exemplary design of a wood grain. The wood grain, or any other design or pattern, can be formed, for example, by configuring the first and second coloring materials 368 and 372 to have different colors, although it is understood that certain texturing and/or other effects potentially can be obtained even if the first and second coloring materials 368 and 372 are of the same color. It is also understood that the coloring sheet 330 could, in other embodiments (not depicted herein,) be formed of more than two coloring materials, and virtually any effect can be achieved with the use of numerous coloring materials having different colors with associated application and curing steps.

An exemplary flowchart of the method of the invention used to form the coloring sheet 330 is depicted generally in FIG. 8. A schematic depiction of the method is provided in FIG. 9, which demonstrates that the coloring sheet 330 can be formed in a single inline process, after which the coloring sheet 330 can be removed from the substrate 334 and rolled into a roll.

The coloring sheet 330 can then be laminated with a plastic sheet to form an improved laminated plastic building panel 350, as is depicted generally in FIG. 10. The coloring sheet 330 and the plastic sheet are laminated together with the first surface 342 facing outwardly, i.e., away from the plastic sheet, such that one observing the laminated plastic building panel 350 can see both the first coloring material 368 and the second coloring material 372 as they are laminated to the plastic sheet.

Having described the presently preferred embodiments, it is to be understood that the invention may be otherwise embodied within the scope and spirit of the appended claims.

1. A method of forming a coloring sheet having a preselected color and being structured to be laminated to a plastic sheet to form a laminated plastic building panel suitable for use on a building, the method comprising:
applying onto a support surface of a substrate a flowable initial material having a polymeric binder and a pigment material, the binder including a plastisol, the support surface having a texture;
curing the flowable initial material to form a relatively less flowable coloring material disposed on the support surface, the coloring material having a first surface and a second surface, the first surface being disposed adjacent the support surface and the second surface being disposed opposite the first surface; and
employing the texture of the support surface to provide the first surface with a matte finish when the coloring material is removed from the substrate.

2. The method of claim 1 wherein said curing the flowable initial material includes providing the second surface with a glossy finish that is relatively more glossy than the matte finish of the first surface.

3. The method of claim 1 wherein the flowable initial material includes plastic particles, said curing the flowable initial material including heating the flowable initial material and fusing together the plastic particles.

4. The method of claim 1 wherein said applying onto a support surface of a substrate a flowable initial material includes applying the flowable initial material onto a web of paper.

5. The method of claim 1 wherein said curing the flowable initial material to form a relatively less flowable coloring material disposed on the support surface includes forming the coloring material into a sheet.

6. A method of forming a laminated plastic building panel having a preselected color and being suitable for use on a building, the method comprising:
applying onto a support surface of a substrate a flowable initial material having a polymeric binder and a pigment material, the binder including a plastisol, the support surface having a texture;
curing the flowable initial material to form a sheet of relatively less flowable coloring material disposed on the support and having a first surface adjacent the support surface;
providing the first surface with a matte finish by curing the flowable initial material adjacent the support surface;
removing the sheet of coloring material from the substrate;
providing a plastic sheet; and
laminating together the plastic sheet and the sheet of coloring material, with the first surface of the sheet of coloring material facing away from the plastic sheet.

7. The method of claim 6 further comprising providing the sheet of coloring material with a second surface disposed opposite the first surface, the second surface having a glossy finish that is relatively more glossy than the matte finish of the first surface.

8. The method of claim 6 wherein the flowable initial material includes plastic particles, said curing the flowable initial material including heating the flowable initial material and fusing together the plastic particles.

9. The method of claim 6 wherein said applying onto a support surface of a substrate a flowable initial material includes applying the flowable initial material onto a web of paper.

10. A coloring sheet structured to be laminated to a plastic sheet to form a laminated plastic building panel having a preselected color and being suitable for use on a building, the coloring sheet comprising:
a sheet of coloring material having a preselected color and having a polymeric binder and a pigment material, the binder including a plastisol;
the sheet of coloring material having a first surface and a second surface;
the first surface having a matte finish; and
the second surface having a glossy finish that is relatively more glossy than the matte finish of the first surface.

11. A laminated plastic building panel having a preselected color and being suitable for use on a building, the plastic building panel comprising:
a plastic sheet;
a coloring sheet having a polymeric binder and a pigment material, the binder including a plastisol;
the plastic sheet and the coloring sheet being laminated together;
an adhesion system that enhances the laminated adhesion of the plastic sheet with the coloring sheet; and
the adhesion system including at least one of an adhesion promoter in the coloring sheet and a primer having an adhesion promoter and being disposed generally between the plastic sheet and the coloring sheet.

12. The laminated plastic building panel of claim 11 wherein the adhesion system includes both the adhesion promoter and the primer.

13. The laminated plastic building panel of claim 11 wherein the coloring sheet is formed of PVC base resins, the adhesion system including the primer, the primer including methyl methacrylate.

14. The laminated plastic building panel of claim 11 wherein the adhesion system includes the primer, the primer being coextruded with the plastic sheet.

15. A method of forming a coloring sheet having at least a first preselected color and being structured to be laminated to a plastic sheet to form a laminated plastic building panel suitable for use on a building, the method comprising:
applying onto a support surface of a substrate a first flowable material having a polymeric first binder and a first pigment material, the first binder including a plastisol;
at least partially curing the first flowable material to form a relatively less flowable first coloring material disposed on the support surface;
applying onto the substrate in contact with the first coloring material a second flowable material having a polymeric second binder and a second pigment material, the second binder including a plastisol; and
performing a curing operation to form the first coloring material and the second flowable material into a coloring sheet having the first coloring material embedded therein.

16. The method of claim 15 wherein said method includes performing all of said steps in a single inline process.

17. The method of claim 15 wherein said applying onto a support surface of a substrate a first flowable material includes applying the first flowable material onto the support surface according to a predetermined pattern.

18. The method of claim 15 wherein the first pigment material and the second pigment material are of different colors.

19. A method of forming a laminated plastic building panel having at least a first preselected color and being suitable for use on a building, the method comprising:
applying onto a support surface of a substrate a first flowable material having a polymeric first binder and a first pigment material, the first binder including a plastisol;
at least partially curing the first flowable material to form a relatively less flowable first coloring material disposed on the support surface;
applying onto the first coloring material a second flowable material having a polymeric second binder and a second pigment material, the second binder including a plastisol;
performing a curing operation to form the first coloring material and the second flowable material into a coloring sheet having a first surface disposed on the support surface, at least a portion of the first coloring material being disposed at the first surface;
removing the sheet of coloring material from the substrate to expose the first surface;
providing a plastic sheet; and
laminating together the plastic sheet and the sheet of coloring material, with the first surface of the sheet of coloring material facing away from the plastic sheet.

20. The method of claim 19 wherein said method includes performing all of said steps in a single inline process.

21. The method of claim 19 wherein said applying onto a support surface of a substrate a first flowable material includes applying the first flowable material onto the support surface according to a predetermined pattern.

22. The method of claim 19 wherein the first pigment material and the second pigment material are of different colors.

23. A coloring sheet structured to be laminated to a plastic sheet to form a laminated plastic building panel having at least a first preselected color and being suitable for use on a building, the coloring sheet comprising:
a sheet of coloring material including a first coloring material embedded in a second coloring material;
the first coloring material having a first preselected color and having a polymeric first binder and a first pigment material, the first binder including a plastisol;
the second coloring material having a second preselected color and having a polymeric second binder and a second pigment material, the second binder including a plastisol; and
the first coloring material being distributed according to a predetermined pattern.

24. The coloring sheet of claim 23 wherein the sheet of coloring material includes a first surface structured to face away from the plastic sheet, at least a portion of the first coloring material being disposed at the first surface.

25. The coloring sheet of claim 23 wherein the first pigment material and the second pigment material are of different colors.

26. A laminated plastic building panel suitable for use on a building, the plastic building panel comprising:
a plastic sheet;
a sheet of coloring material including a first coloring material embedded in a second coloring material;
the first coloring material having a first preselected color and having a polymeric first binder and a first pigment material, the first binder including a plastisol;
the second coloring material having a second preselected color and having a polymeric second binder and a second pigment material, the second binder including a plastisol; and
the plastic sheet and the coloring sheet being laminated together.

27. The laminated plastic building panel of claim 26 wherein the sheet of coloring material includes a first surface, at least a portion of the first coloring material being disposed at the first surface, the first surface facing away from the plastic sheet.

28. The laminated plastic building panel of claim 26 wherein the first coloring material is distributed according to a predetermined pattern.

29. The laminated plastic building panel of claim 26 wherein the first pigment material and the second pigment material are of different colors.

30. The coloring sheet of claim 10 wherein sheet of coloring material is substantially free of flattening agents.
